(19) United States
(12) Patent Application Publication
(10) Pub. No.: US 2022/0407998 A1
(43) Pub. Date: Dec. 22, 2022

(54) MULTI-CAMERAS WITH SHARED CAMERA APERTURES

(71) Applicant: Corephotonics Ltd., Tel Aviv (IL)

(72) Inventors: Gil Bachar, Tel Aviv (IL); Gal Shabtay, Tel Aviv (IL); Noy Cohen, Tel Aviv (IL); Ephraim Goldenberg, Tel Aviv (IL); Ruthy Katz, Tel Aviv (IL); Anat Leshem Gat, Tel Aviv (IL); Oded Gigushinski, Tel Aviv (IL); Nadav Geva, Tel Aviv (IL)

(21) Appl. No.: 17/895,089

(22) Filed: Aug. 25, 2022

Related U.S. Application Data
(63) Continuation of application No. 16/978,692, filed on Sep. 5, 2020.
(60) Provisional application No. 62/726,357, filed on Sep. 3, 2018.
(60) Provisional application No. 62/716,482, filed on Aug. 9, 2018.

(51) Int. Cl. H04N 5/225; G02B 13/00; G02B 27/10; H04N 5/33

(52) U.S. Cl. CPC H04N 5/2258; G02B 13/0045; G02B 13/0065; G02B 27/1013; H04N 5/2254; H04N 5/332

(57) ABSTRACT

Multi-cameras in which two sub-cameras share a camera aperture. In some embodiments, a multi-camera comprises a first sub-camera including a first lens and a first image sensor, the first lens having a first optical axis, a second sub-camera including a second lens and a second image sensor, the second lens having a second optical axis, and an optical element that receives light arriving along a third optical axis into the single camera aperture and splits the light for transmission along the first and second optical axes.

### CROSS REFERENCE TO RELATED APPLICATIONS

This is a continuation of U.S. patent application Ser. No. 16/978,692 filed Sep. 5, 2020, which was a 371 application from international patent application No. PCT/IB2019/054360 filed May 26, 2019, which claims the benefit of priority from U.S. Provisional patent applications No. 62/716,482 filed Aug. 9, 2018 and 62/726,357 filed Sep. 3, 2018, both of which are incorporated herein by reference in their entirety.

### FIELD

Embodiments disclosed herein relate in general to digital cameras and in particular to small digital multi-cameras in which two sub-cameras share an aperture.

### BACKGROUND AND TECHNICAL PROBLEM

In recent years, multi-cameras (i.e. imaging systems with more than one camera) such as dual-cameras (i.e. imaging systems with two cameras or two “sub-cameras”) and triple-cameras (i.e. imaging systems with three cameras or sub-cameras) have become common in many modern electronic devices (e.g. a cellphone, TV, tablet, laptop etc.). In known multi-cameras, each camera may comprise an image sensor and a lens. Each lens may have a lens aperture and an optical axis passing through the center of the lens aperture. In known multi-cameras, two cameras may be directed at the same object or a scene such that an image is captured in both cameras with a similar field of view (FOV). However, a finite (larger than zero) distance between the centers of any two cameras, known as a “baseline”, may result in changes in the scene, occlusions, and varying disparity between objects in the scene (see e.g. co-owned U.S. Pat. No. 9,185,291) Thus, there is a need for, and it would be advantageous to have multi-cameras with zero disparity.

### SUMMARY

In various exemplary embodiments, there are provided dual-cameras with a single camera aperture, comprising: a first sub-camera including a first lens and a first image sensor, the first lens having a first optical axis; a second sub-camera including a second lens and a second image sensor, the second lens having a second optical axis; and an optical element that receives light arriving along a third optical axis into the single camera aperture and splits the light for transmission along the first and second optical axes.

In some exemplary embodiments, the splitting the light between the first and second optical axes is such that light in the visible light (VL) range is sent to the first sub-camera and light in the infra-red (IR) light range is sent to the second sub-camera. The IR range may be for example between 700 nm and 1500 nm.

In some exemplary embodiments, the second sub-camera is operative to be a time-of-flight (TOF) camera.

In some exemplary embodiments, the splitting the light between the first and second optical axes is such that the light is split 50% to each sub-camera.

In some exemplary embodiments, the dual-camera is a zoom dual-camera. The zoom dual-camera may operate in the visible light range.

In some exemplary embodiments, the dual-camera is a TOF zoom dual-camera.

In various exemplary embodiments, there are provided dual-cameras with a single camera aperture, comprising: an optical path folding element for folding light from a first optical path to a second optical path; a lens having an optical axis along the second optical path; a beam splitter for splitting light from the second optical path to a third optical path and to a fourth optical path; a first image sensor positioned perpendicular to the third optical path; and a second image sensor positioned perpendicular to the fourth optical path.

In some exemplary embodiments, the splitting the light between the third and fourth optical paths is such that light in most of a VL wavelength range is sent to the third optical path, and light in most of an IR wavelength range is sent to the fourth optical path.

In some exemplary embodiments, a dual-camera further comprises a lens element positioned between the beam splitter and the first image sensor.

In some exemplary embodiments, a dual-camera further comprises a lens element positioned between the beam splitter and the second image sensor.

In some exemplary embodiments, the lens has a lens aperture, wherein the lens aperture is partially covered by a filter such that visible light is transferred through one part of the aperture and IR light is transferred trough another part of the lens aperture.

In various exemplary embodiments, there are provided systems comprising: a beam splitter for splitting light arriving at a single system aperture along a first optical path to light transmitted along a second optical path and a third optical path; a camera having a lens with an optical axis along the second optical path and an image sensor positioned perpendicular to the second optical path; and a light source positioned so that the light from the light source travels along the third optical path to the beam splitter in the first optical path direction.

In some exemplary embodiments, the camera is a visible light camera.

In some exemplary embodiments, the light source is an IR light source.

In some exemplary embodiments, the beam splitter is operative to split the light along the first optical path, such that most of visible light is sent to the second optical path and most of IR light is sent to the third optical path.

In an exemplary embodiment, there is provided a system comprising: a TOF light source; a TOF sub-camera; and a VL sub-camera, wherein the TOF sub-camera and the VL sub-camera share a single camera aperture.

In an exemplary embodiment, there is provided a system comprising: a structured light (SL) source module; a SL sub-camera; and a VL sub-camera, wherein the SL sub-camera and the VL sub-camera share a single camera aperture.

In various exemplary embodiments, there are provided systems comprising a smartphone and a dual-camera as above, wherein the dual-camera does not add height to the smartphone.

In various exemplary embodiments, there are provided systems comprising a smartphone and system as above, wherein the system does not add height to the smartphone.

### BRIEF DESCRIPTION OF THE DRAWINGS

Aspects, embodiments and features disclosed herein will become apparent from the following detailed description when considered in conjunction with the accompanying drawings, in which:

FIG. 1A shows in isometric view an embodiment of a dual-camera with a single camera aperture disclosed herein;

FIG. 1B shows the dual-camera of FIG. 1A in a side view (cross section);

FIG. 1C shows in cross section another embodiment of a dual-camera with a camera single aperture disclosed herein;

FIG. 1D shows the dual-camera of FIG. 1A embedded in host device with a screen as a front camera;

FIG. 1E shows a section of the screen and host device of FIG. 1D in a top view;

FIG. 1F shows an embodiment of a system in which a dual-camera as in FIG. 1A is integrated with a light source;

FIG. 1G shows the dual-camera of FIG. 1A embedded in a host device with a screen as a back camera;

FIG. 2A shows in isometric view another embodiment of a dual-camera with a single camera aperture disclosed herein;

FIG. 2B shows in cross section the dual-camera of FIG. 2A;

FIG. 2C shows in cross section yet another embodiment of a dual-camera with a single camera aperture disclosed herein;

FIG. 2D shows isometric view yet another embodiment of a dual-camera with a single camera aperture disclosed herein;

FIG. 2E shows in cross section the dual-camera of FIG. 2D;

FIG. 2F shows an optional front lens aperture of the first lens element in a lens in the dual-camera of FIG. 2A;

FIG. 3A shows in isometric view an embodiment of a dual-camera with a single camera aperture and with a light source, disclosed herein;

FIG. 3B shows in cross section the dual-camera of FIG. 3A;

FIG. 4A shows yet another embodiment of a dual-camera with a single camera aperture disclosed herein in isometric view;

FIG. 4B shows the dual-camera of FIG. 4A in a top view;

FIG. 5A shows an embodiment of a triple-camera with two camera apertures disclosed herein in isometric view;

FIG. 5B shows the dual-camera of FIG. 5A in a side view;

FIG. 6A shows an embodiment of another triple-camera with two camera apertures disclosed herein in isometric view;

FIG. 6B shows the dual-camera of FIG. 6A in a top view.

### DETAILED DESCRIPTION

In various embodiments there are disclosed dual-cameras and triple cameras in which two sub-cameras share a single aperture. In some embodiments, any two of the sub-cameras may differ in the light wavelength ranges they operate in (i.e. wavelengths sensed by their respective image sensors), e.g. infrared (IR) vs. visible light (VL), red vs. green vs. blue, etc. In some embodiments, the sub-cameras differ in field of view (FOV) and/or resolution and/or distortion and/or lens aperture size. For example, resolution=pixel count. In some use examples, embodiments, systems and cameras disclosed herein may be incorporated in host devices. The host devices may be (but are not limited to) smartphones, tablets, personal computers, laptop computers, televisions, computer screens, vehicles, drones, robots, smart home assistant devices, surveillance cameras, etc.

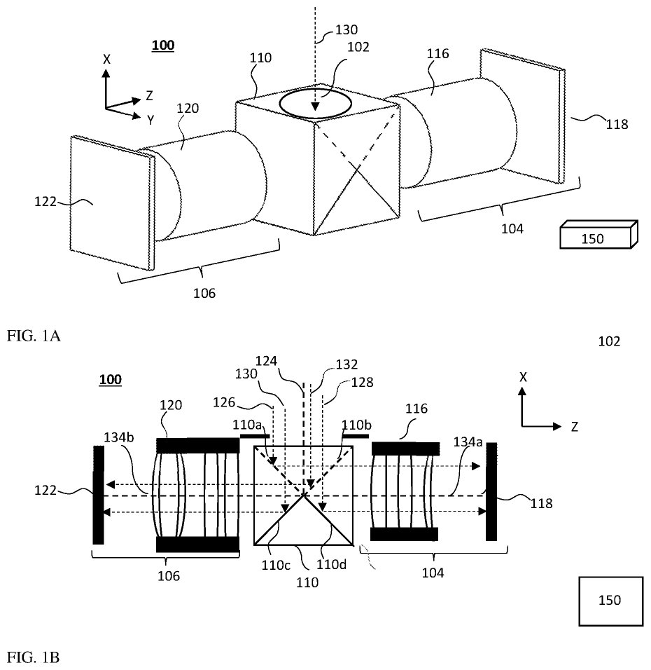

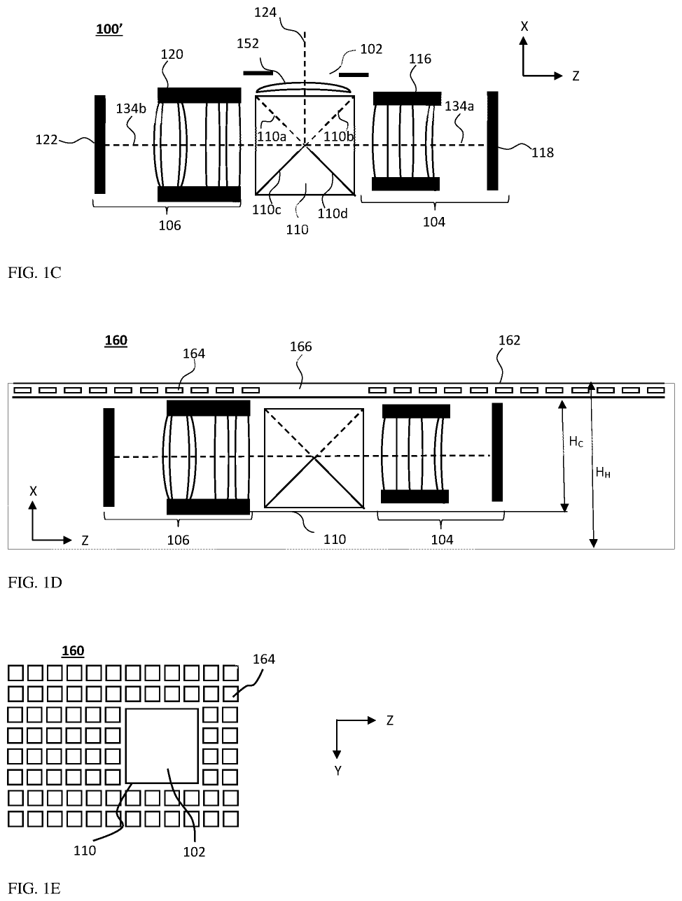

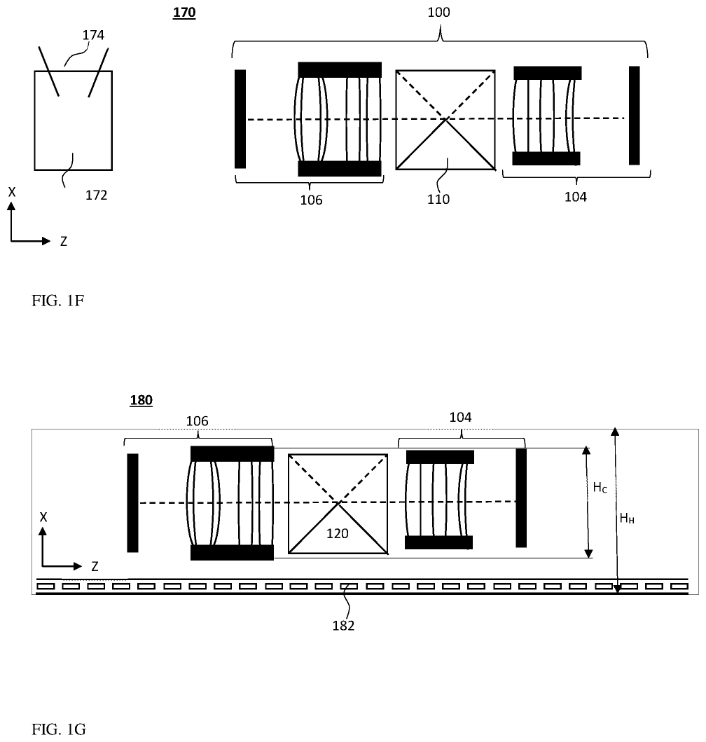

FIGS. 1A and 1B show in isometric view and cross section, respectively, an embodiment numbered 100 of a dual-camera with a shared camera aperture 102 disclosed herein. Camera 100 comprises a first folded sub-camera 104, a second folded sub-camera 106 and an optical element 210. In some embodiments, optical element 210 may be a beam splitter. In some embodiments, optical element 210 may be a combination of two prisms with a beam splitter coating. Each sub-camera includes a respective lens and a respective image sensor (or simply “sensor”). Thus, first folded sub-camera 104 includes a first lens 116 and a first sensor 118, and second folded sub-camera 106 includes a second lens 120 and a second sensor 122. First lens 116 has a first optical axis 134a and second lens 120 has a second optical axis 134b. According to an example, first optical axis 134a and second optical axis 134b may be on the same axis (i.e. may converge). Lenses 116 and 120 are shown with 3 and 4 lens elements respectively. This is however non-limiting, and each lens may have any number of elements (for example between 1 and 7 lens elements). The same is applied to all other lenses presented hereafter. Each sub-camera may include additional elements that are common in known cameras, for example a focusing (or autofocusing, AF) mechanism, an optical image stabilization (OIS) mechanism, a protective shield, a protective window between the lens and the image sensor to protect from dust and/or unneeded/unwanted light wavelengths (e.g. IR, ultraviolet (UV)), and other elements known in the art. For simplicity, such known elements are not described and shown in the figures. Camera 100 as well as all other cameras describe herein further comprises a controller 150 for controlling various camera functions.

Aperture 102 is positioned in a first light path 130 and an object or scene to be imaged (not shown). In FIGS. 1A and 1B, first light path 130 is along the X axis. Beam splitter 110 splits the light arriving through camera aperture 102 such that some of the light is sent to sub-camera 104 and some of the light is sent to sub-camera 106, as detailed below. An optical axis 124 passes through beam splitter 110 and defines a center of camera aperture 102. Light split by beam splitter 110 along optical axis 122 is split to two parts, along optical axes 134a and 134b. As a result, the two sub-cameras 104 and 106 have a single camera aperture, i.e. have a zero base-line.

Beam splitter 110 comprises four reflection surfaces 110a-d. In an embodiment, the four reflection surfaces 110a-d may function as follows: surface 110a may split light such that IR light is 100% reflected by 90 degrees and VL is 100% transmitted, surface 110b may split the light such the IR light is 100% transmitted by 90 degrees and VL is 100% reflected, surface 110c may reflect 100% of the VL, and surface 110d may reflect 100% of the IR light.

In another embodiment, each of surfaces 110a and 1100 act as a beam splitter with a reflection (or transmission) coefficient between 10% to 90% (and in one example 50%), and surfaces 110c and 110d act each as a fully reflective mirror with a 100% reflection coefficient.

In some examples, first lens 116 and second lens 120 may be the same. In some examples, first lens 116 and second lens 120 may differ in their optical design, for example, by having one or more of the following differences: different effective focal length (EFL), different lens aperture size, different number of lens elements, different materials, etc. In some examples, image sensor 118 and second image sensor 122 may be the same. In some examples, image sensor 118 and second image sensor 122 may differ in their optical design, for example, by having one or more of the following differences: different numbers of pixels, different color filters (e.g. VL and IR, or red and blue etc.), different pixel size, different active area, different sensor size, different material (e.g. silicon and other types of semiconductors). While in the following, the description continues with express reference to RGB sensors and images, “RGB” should be understood as one non-limiting example of color sensors (sensors with color filter arrays including having at least one of RGB color filters) and color images. In some examples, a TOF, SL or IR sub-camera may have a sensor with a pixel size larger than the RGB sensor pixel size, and a resolution smaller than that of a RGB sub-camera. In various examples, the TOF sensor pixel size is larger than the Wide/Tele sensor pixel size and is between 1.6 μm and 10 μm.

According to one example, first sub-camera 104 may be an IR sensitive camera, (e.g. a camera operational to capture images of structured light source, a time-of-flight (TOF) camera, a thermal imaging camera etc.) and second sub-camera 106 may be a camera in the VL wavelength range (e.g. a red green blue (RGB) camera, a monochromatic camera, etc.). According to one example, the two cameras may vary in their lens EFL and image sensor pixel sizes, such that the dual-camera is a zoom dual-camera. Examples of usage and properties of zoom dual-cameras can be found in co-owned U.S. Pat. Nos. 9,185,291 and 9,402,032, however in U.S. Pat. No. 9,185,291 the two cameras do not share a camera aperture and thus have a non-zero base-line.

According to yet another example, the two sub-cameras 104 and 106 may be sensitive to the same light spectrum, e.g. the two sub-cameras may both be TOF sub-cameras, VL sub-cameras, IR sub-cameras, thermal imaging sub-cameras, etc.

In camera 100, in a first operation mode, and as indicated by arrows 126 and 128 in FIG. 1B, a first portion of the light (e.g. IR light, or a part of all of the light in all wavelengths) may be reflected by either surface 110a or 110d and enter sub-camera 104 to form an image of a scene (not shown). In a second operation mode and as indicated by arrows 130 and 132 in FIG. 1B, a second portion of the light (e.g. VL, or a part of all of the light in all wavelengths) may be reflected by either surface 110c or 110b, and enter sub-camera 106 to form an image of the object or scene (not shown). The two operation modes can be operational simultaneously (i.e. capturing images by the two sub-cameras at the same time) or sequentially (i.e. capturing one image by either one of the sub-cameras and then another image by the other sub-camera).

FIG. 1C shows another embodiment of a dual-camera with a single camera aperture disclosed herein and numbered 100′. Camera 100′ is similar to camera 100, except that it includes a lens 152 before optical element 110 in the optical path from an imaged object.

Having a dual-camera with a single camera aperture can result in several advantages. First, having a zero base-line reduces computational steps required to match (rectify) between the two images. Second, occlusions and varying disparity between objects in the scene may be eliminated or greatly reduced, such that registration between images and resulting calculation time are greatly reduced. Third, the calibration steps needed to align the two sub-cameras (in the factory or during the life-time of the dual-camera) are simplified. Fourth, in cases where an external surface area of a host device incorporating a dual-camera is scarce (limited in size), a single camera aperture may save real estate. FIG. 1D shows camera 100 hosted in a host device 160 (e.g. cellular phone, tablet, TV, etc.) below a screen 162, screen 162 comprising a pixel array 164 and an opening (hole) 166 in the pixel array. FIG. 1E shows device 160 from a top view. Camera aperture 102 of camera 100 is located below hole 166, such that it can capture images of a scene.

The design of camera 100 is such that its height H_{C} along the optical axis (124) direction is reduced, due to the structure of beam splitter 110 which splits light to left and right directions (orthogonal to optical axis 124 or the Z direction in the provided coordinate system). According to some examples, the total height H_{C} of camera 100 along optical axis 124 may be less than 4 mm, 5 mm or 6 mm. As shown in FIG. 1D, height H_{C} is smaller than a height H_{H} of the host device (e.g. a smartphone) such that a dual-camera disclosed herein does not add to the height H_{H} of the smartphone or other host devices in which it is incorporated. In one example, (FIG. 1D) camera 100 may be used as a front camera of a host device (e.g. smartphone, tablet, laptop, etc.). FIG. 1G shows camera 100 hosted in a host device 180 that has a screen 162. In an example related to FIG. 1G, camera 100 may be used as a back camera (facing the side away from the screen) of the host device.

FIG. 1F shows an example of a system 170 that comprises a camera such as camera 100 and a light source 172 having a light source aperture 174 through which light is emitted. Light source 172 may be, for example, an ambient light source a polarized light source, a narrow band IR light source, a structured light source, a flash light, etc. The drawing of light source 172 is schematic. Light source 172 may comprise some or all of the following elements: a light source (e.g. light emitting diode (LED), a vertical cavity surface emitting laser (VCSEL), laser diode, etc.) and passive optics (lens elements, mirrors, prisms, diffractive elements, phase masks, amplitude masks, etc.).

According to an example, system 170 may serve as a dual-camera with a single camera aperture comprising a TOF sub-camera and a VL sub-camera. In this example, sub-camera 104 is an IR camera and sub-camera 106 is a VL camera. In this example, light source 172 is a TOF light source, which may provide ambient pulsed IR light. The ambient pulsed IR light source may be synchronized with sub-camera 104 exposure timing.

According to another example, system 170 may serve as a dual-camera with a single camera aperture comprising a SL sub-camera and a VL sub-camera. In this example, sub-camera 104 is an IR camera and sub-camera 106 is a VL camera. In this example, light source 142 is a SL-module, which may provide patterned light enabling depth maps, facial recognition, etc. The SL module may be calibrated with sub-camera 104 to allow accuracy in depth maps.

Like camera 100, system 170 may be positioned below a screen of a host device, with respective holes in pixel arrays above camera aperture 102 and light source aperture 174. Like camera 100, system 170 may be facing the front or back side of the host device.

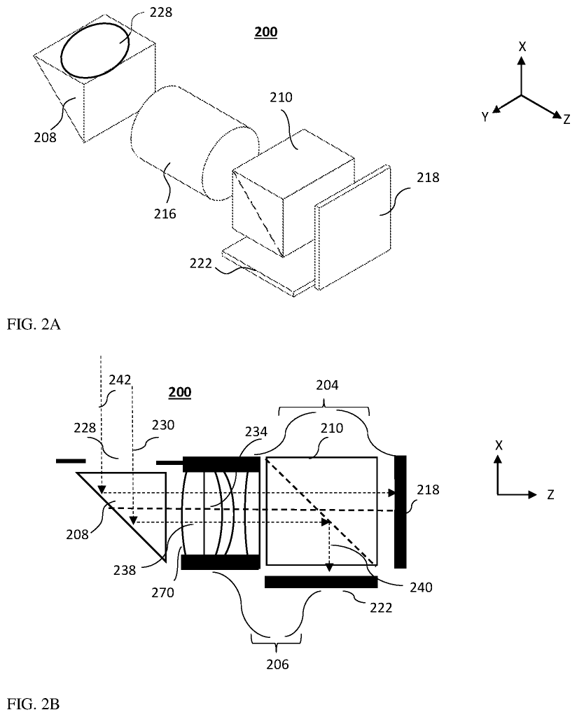

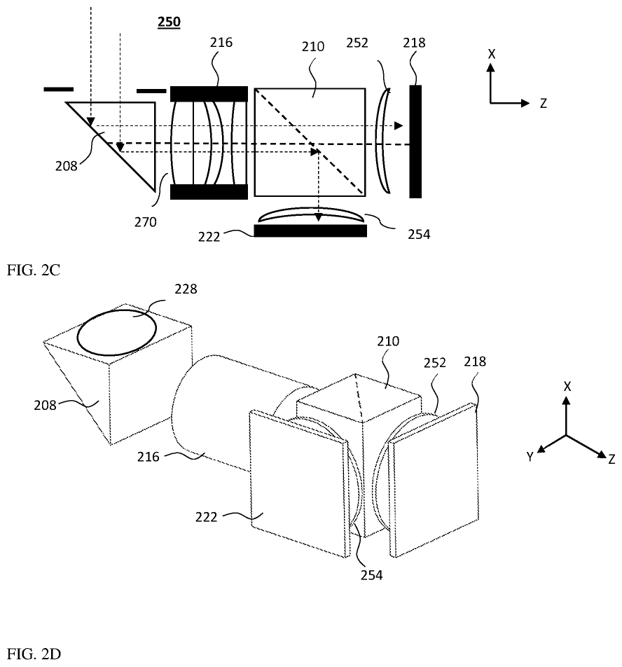

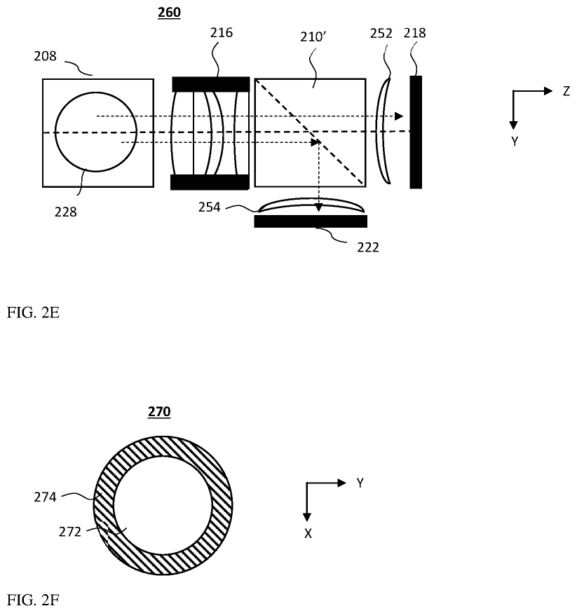

FIGS. 2A and 2B show in, respectively, isometric view and cross section of another embodiment numbered 200 of a dual-camera with a single camera aperture disclosed herein. Camera 200 comprises two (first and second) folded sub-cameras 204 and 206, an OPFE 208 and a beam splitter 210. Sub-cameras 204 and 206 share a single lens 216 but have each an image sensor, respectively sensors 218 and 222. A single aperture 228, shared by sub-cameras 204 and 206 is positioned in a light path 230 between OPFE 208 and the object or scene to be imaged. In FIGS. 2A and 2B, light path 230 is along the X axis. Lens 216 has a lens optical axis 234 parallel to the Z axis. OPFE 208 redirects light from light path 230 to a light path 238 parallel to lens optical axis 234. Beam splitter 210 splits the light from light path 238 such that one part of the light continues in light path 238 to sensor 218 and another part of the light is directed along a third optical path 240 toward sensor 222.

Camera 200 may further comprise elements that are common in other typical cameras and are not presented for simplicity, for example elements mentioned above with reference to camera 100 and sub cameras 104-106. As in camera 100, first image sensor 218 and second image sensor 222 may be the same, or may differ in their optical design. Lens 216 may be design such that it fits optical demands of the two image sensors according to their differences (e.g. lens 216 can be designed to focus light in all the VL wavelength range and in part of the IR wavelength range, or lens 216 can be designed to focus light in all the VL wavelength range and in a few specific IR wavelengths correlated to an application such as TOF, SL, etc.).

According to an example, beam splitter 210 may split light evenly (50%-50%) between transferred and reflected light. According to an example, beam splitter 210 may transfer IR light (all IR range or specific wavelengths per application) and reflect VL. According to an example, beam splitter 210 may reflect IR light (all IR range or specific wavelengths per application) and transfer VL. According to an example, beam splitter 210 may reflects light in some wavelengths (red, IR, blue, etc.) and transfer the rest of the light (i.e. beam splitter 210 may be a dichroic beam splitter).

According to one example, first sensor 218 may be an IR sensitive sensor (e.g. a sensor operational to capture images for SL application, TOF application, thermal applications), and second sensor 222 may be a sensor in the VL wavelength range (e.g. a RGB sensor, a monochromatic sensor, etc.).

In dual-camera 200, in a first operation mode, a first portion light indicated by arrow 242 (e.g. only IR light, only VL, or a part of all of the light in all wavelengths) may be transferred (pass through the) beam splitter (without reflection, or with little reflection) and enter first image sensor 218 to form an image of a scene (not shown). In a second operation mode and as indicated by arrow 230 in FIG. 2B, a second portion of the light (e.g. only IR, only VL, or a part of all of the light in all wavelengths) may be reflected by beam splitter 210 and enter image sensor 222 to form an image of a scene (not shown). The two operation modes can be operational simultaneously (i.e. capturing images by the two cameras at the same time) or sequentially (i.e. capturing one image by either one of the cameras and then another image by the other camera).

FIG. 2C shows in cross section yet another embodiment 250 of a dual-camera with a single camera aperture similar to camera 200 with the following differences: an optional additional first field lens 252 is positioned between beam splitter 210 and sensor 218, and an additional optional second field lens 254 is positioned between beam splitter 210 and image sensor 222. First and second field lenses 252-254 are shown in FIG. 2B as a single lens element, but may include a plurality of lens elements. The purpose of the first and second field lenses is to correct for field curvatures due to difference in the optical needs of image sensor 218 and image sensor 222. For example, IR wavelengths and VL wavelengths may have different field curvatures. In some embodiments, only one of field lenses 252 or 254 may be present.

FIGS. 2D-2E show yet another embodiment 260 of a dual-camera with a single camera aperture similar to cameras 200 and 250. FIG. 2D shows an isometric view and FIG. 2E is shown from a top view, i.e. in the Y-Z plane. Camera 260 has the following differences from camera 250: in camera 260, a beam splitter 210′ splits the light in the Y-Z plane, in contrast with beam splitter 210 of cameras 200 and 250, which splits the light in the Z-X plane. All other elements are similar. As in camera 250, field lenses 252 and 254 are only optional (i.e. both of them, one of them or none of them can be present).

FIG. 2F shows an optional front lens aperture 270 of the first lens element in lens 216 (270 is also marked in FIGS. 2B and 2C). In an example, front lens aperture 270 may be designed (“divided”) such that it has two areas: a central (inner) area 272, which is clear to all wavelengths, and a second (outer) area 274 which may pass some of the wavelength and block other wavelengths. For an example, area 274 may block VL and pass IR light or vice-versa. As a result, the lens clear aperture (the area through which light can enter the cameras), and resulting f-number (defined as the EFL divided by the lens clear aperture diameter), may change between different wavelengths. In other examples, the division of lens aperture 270 may be different, e.g. lens aperture 270 may be partially covered by a filter such that some light (e.g. VL) is transferred through one part of the lens aperture and some (e.g. IR) light is transferred trough another part of the lens aperture.

The advantages of dual-camera with a single camera aperture like cameras 200, 250 and 260 are similar to these specified above regarding camera 100. Cameras 200 and 250 can be positioned below a screen, similar to camera 100 above in FIGS. 1D and 1E.

Like camera 100, cameras 200, 250 and 260 may be part of a system comprising an IR source and may serve as dual-camera with a single camera apertures with a TOF sub-camera and a VL sub-camera, or as dual-camera with a single camera apertures with a SL sub-camera and a VL sub-camera. Like camera 100, cameras 200, 250 and 260 may be positioned below a screen with respective holes in pixel arrays above camera aperture 201. Like camera 100, cameras 200, 250 and 260 may be facing the front or the back side of a host device.

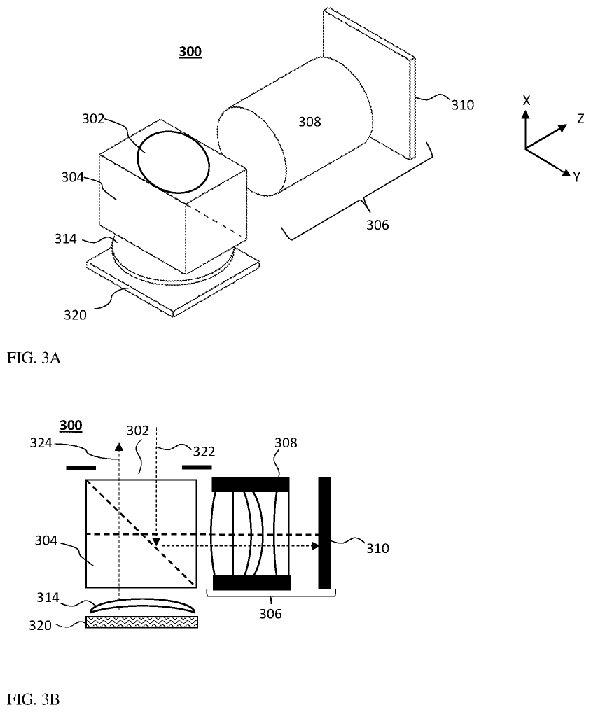

FIGS. 3A-B show in isometric view and cross section respectively an embodiment numbered 300 of a single camera with a light source 320 sharing a single system aperture 302. System 300 includes a beam splitter 304 that may be similar to beam splitter 210 in description and capabilities. System 300 further includes a sub-camera 306 comprising a lens 308 and an image sensor 310. Camera 306 may include other elements that are not seen, similar to those described above for sub-cameras 104 and 106. Light source 310 may be for example a wide (broad) wavelength light source, a single wavelength light source, a light source with a few specific wavelengths, a coherent light source, a non-coherent light source, etc. Light source 320 may for example be limited to the IR wavelength range or to the VL wavelength range. Light source 320 may be for example a TOF light source, an ambient light source, a flood illumination light source, a SL source, a proximity sensor emitter, an iris sensor emitter, notification light, etc. System 300 may (or may not) include an optional lens 314. Lens 314 may be used to increase the numerical aperture (NA) of light source 320. In system 300, in a first operation mode, and as indicated by arrow 322 in FIG. 3B, a portion of the light entering beam splitter 302 (e.g. only IR light, only VL, or a part of all of the light in all wavelength) may be reflected by beam splitter and enter sub-camera 306 to form an image of a scene (not shown). In other words, light 322 is the portion of light 302 reflected from an object. In a second operation mode and as indicated by arrow 324 in FIG. 3B, light from light source 320 may be transferred by beam splitter 304. According to one example, sub-camera 306 may capture images in the VL range, light source 320 may be an IR source and beam splitter that reflects light in the VL range and transfers light in the IR range. System 300 may be located below a screen in a host device like camera 100 in FIG. 1D, below a screen with respective holes in pixel arrays above system aperture 302. Like camera 100, system 300 may be facing the front or back side of a host device.

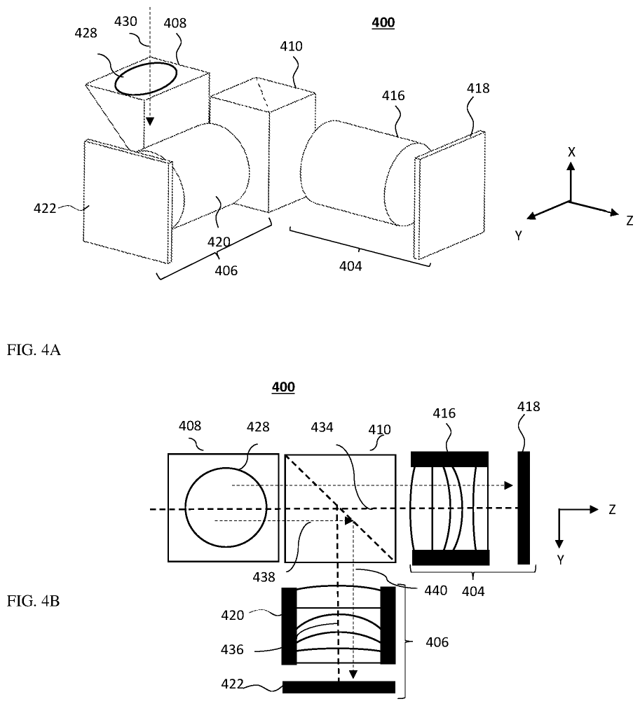

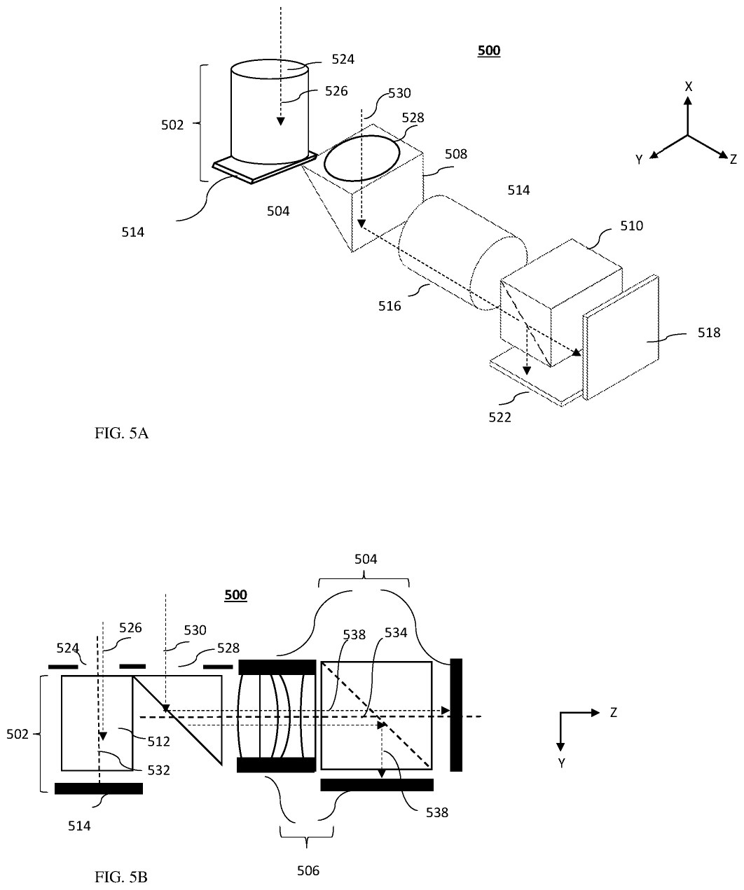

FIGS. 4A and 4B show another embodiment numbered 400 of a dual-camera with a shared single aperture disclosed herein, in, respectively, an isometric view and a side view. Camera 400 comprises a first folded sub-camera 404, a second folded sub-camera 406, an OPFE 408 and a beam splitter 410. Each sub-camera includes a respective lens and a respective image sensor. Thus, first folded sub-camera 404 includes a lens 416 and a sensor 418, and second folded sub-camera 406 includes a lens 420 and a sensor 422. An aperture 428, shared by sub-cameras 404 and 406, is positioned in a first light path 430 between OPFE 408 and the object or scene to be imaged. In FIGS. 4A and 4B, first light path 630 is along the X axis. Lens 416 has a lens optical axis 434 parallel to the Z axis and lens 420 has a lens optical axis 436 parallel to the Y axis. OPFE 408 redirects light from first light path 430 to a second light path 438 parallel to lens optical axis 434. Beam splitter 410 splits the light from second light path 438 such that one part of the light continues in second light path 438 to sensor 418 and another part of the light is directed along a third optical path 440 parallel to third lens optical axis 436 toward sensor 422.

In some embodiments, folded sub-cameras 404 and 406 may be sensitive to the same light spectrum, e.g. the two sub-cameras may both be TOF sub-cameras, VL sub-cameras, IR sub-cameras, thermal imaging sub-cameras, etc. In some embodiments, folded sub-cameras 404 and 406 may be sensitive to different light spectra. For example, one sub-camera may be a TOF camera, and the other sub-camera may be a VL camera. In an example, the VL sub-camera may be a RGB camera with a RGB sensor.

Camera 400 may be positioned below a screen with a holes in pixel arrays above camera aperture 428. Like other cameras above or below, camera 400 may be facing the front side or the back side of a host device.

FIGS. 5A and 5B show an embodiment numbered 500 of a triple-camera with two apertures disclosed herein, in, respectively, an isometric view and a side view. Camera 500 comprises an upright sub-camera 502 with a lens 512 and an image sensor 514, an OPFE 508, a beam splitter 510, and two (first and second) folded sub-cameras 504 and 506 that share a single lens 516 but have each an image sensor, respectively sensors 518 and 522. In essence, triple-camera 500 includes a camera like dual-camera 200 of FIG. 2A plus upright sub-camera 502. A first aperture 524 is positioned in a first light path 526 between lens 512 and an object or scene to be imaged (not shown). A second aperture 528, shared by sub-cameras 504 and 506 is positioned in a light path 530 between OPFE 508 and the object or scene to be imaged. In FIGS. 5A and 5B, light paths 526 and 530 are along the X axis and parallel to each other and to a first lens optical axis 532 of lens 512. Lens 516 has a lens optical axis 534 parallel to the Z axis. OPFE 508 redirects light from light path 530 to a light path 538 parallel to second lens optical axis 534. Beam splitter 510 splits the light from light path 538 such that one part of the light continues in light path 538 to sensor 518 and another part of the light is directed along a third optical path 540 toward sensor 522.

Note that while in camera 500 upright sub-camera 502 is shown to the left (negative Z direction) of OPFE 508 this is by no means limiting, and the upright sub-camera may be positioned in other locations relative to the OPFE and the two folded sub-cameras. In an example, upright sub-camera 502 may be positioned to the right (positive Z direction) of first folded sub-camera 504 along lens optical axis 534.

Note that while sensor 522 is shown as lying in the YZ plane (like in camera 200) it can also lie in a XZ plane, provided that the beam splitter is oriented appropriately.

In some exemplary embodiments, two of the three sub-cameras may be sensitive to the same light spectrum, e.g. the two sub-cameras may both be TOF sub-cameras, VL sub-cameras, IR sub-cameras, thermal imaging sub-cameras, etc. For example, upright sub-camera 502 and one of the folded sub-cameras 504 and 506 may be VL cameras, while the other of folded sub-cameras 504 and 506 a time-of-flight (TOF) camera. For example, upright sub-camera 502 may be a TOF camera, and both folded sub-cameras 504 and 506 may be VL cameras. In an example, sub-camera 502 may be a RGB camera with a RGB sensor, sub-camera 504 may be a TOF camera with a TOF sensor and sub-camera 506 may be a RGB camera with a RGB sensor. In an example, sub-camera 502 may be a RGB camera with a RGB sensor, sub-camera 504 may be a RGB camera with a RGB sensor and sub-camera 506 may be a TOF camera with a TOF sensor. In an example, sub-camera 502 may be a TOF camera with a TOF sensor, sub-camera 504 may be a RGB camera with a RGB sensor and sub-camera 506 may be a RGB camera with a RGB sensor. In other embodiments, two of the three sub-cameras may be TOF cameras, with the third sub-camera being a RGB sub-camera.

In an example, a folded sub-camera 504 or 506 may be a Tele RGB camera with a Tele RGB sensor with a resolution A, a pixel size B, a color filter array (CFA) C, a first type of phase detection pixels and a sensor (chip) size D, a sub-camera 502 may be a Wide RGB sub-camera with a Wide RGB sensor with a resolution A′, a pixel size B′, a CFA C′, a second type of phase detection pixels and a sensor (chip) size D′, and the TOF sub-camera may have a sensor with a pixel size B″, wherein:

resolution A is equal to or less than A′ (i.e. A≤A′);

pixel size B is equal or greater than B′ and smaller than B″ (B″>B≥B′);

color filter array C is a standard CFA such as Bayer;

color filter array C′ is a non-standard or CFA;

the first type of phase detection pixels are masked phase detection auto focus (PDAF) or Super phase detection (PD) pixels;

the second type of phase detection pixels are masked PDAF or SuperPD pixels;

the pixel size is between 0.7 to 1.6 μm for each of B, B′ and B″; and

the chip size D is smaller than chip size D′.

Masked PDAF is known in the art, see e.g. U.S. patent Ser. No. 10/002,899. SuperPD is described for example in U.S. Pat. No. 9,455,285.

Camera 500 may be positioned below a screen with respective holes in pixel arrays above camera apertures 524 and 528. Like other cameras above or below, camera 500 may be facing the front side or the back side of a host device.

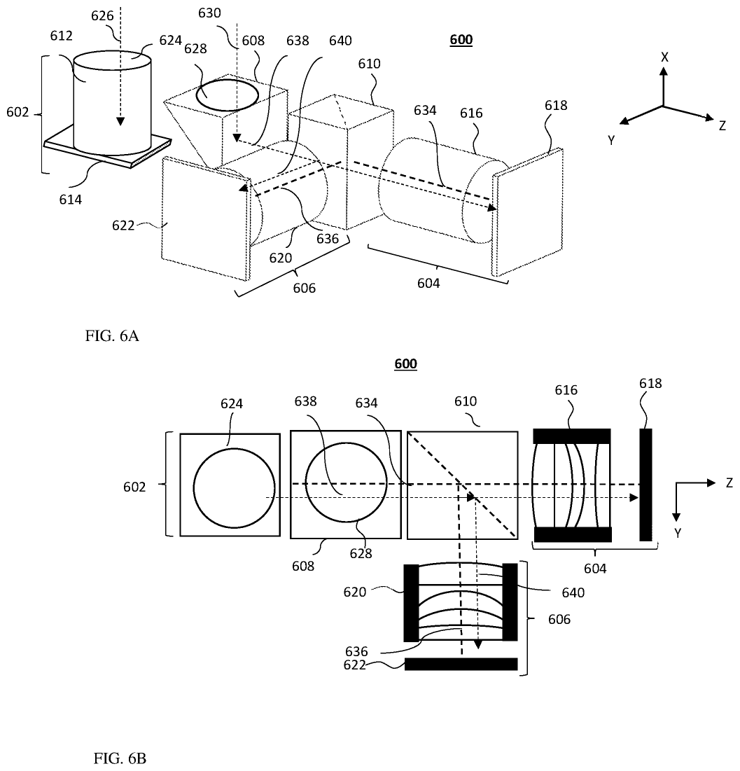

FIGS. 6A and 6B show yet another embodiment numbered 600 of a triple-camera with two apertures disclosed herein, in, respectively, an isometric view and a top view. Camera 600 comprises an upright sub-camera 602, a first folded sub-camera 604, a second folded sub-camera 606, an OPFE 608 and a beam splitter 610. In essence, triple-camera 600 includes a camera like dual-camera 400 plus upright sub-camera 602. Each sub-camera includes a respective lens and a respective image sensor. Thus, upright sub-camera 602 includes a lens 612 and a sensor 614, first folded sub-camera 604 includes a lens 616 and a sensor 618, and second folded sub-camera 606 includes a lens 620 and a sensor 622. A first aperture 624 is positioned in a first light path 626 between lens 612 and an object or scene to be imaged (not shown). A second aperture 628, shared by sub-cameras 604 and 606 is positioned in a light path 630 between OPFE 608 and the object or scene to be imaged. In FIGS. 6A and 6B, light paths 626 and 630 are along the X axis and parallel to each other and to a first lens optical axis 632 of lens 612. Lens 616 has a second lens optical axis 634 parallel to the Z axis and lens 620 has a third lens optical axis 636 parallel to the Y axis. OPFE 608 redirects light from light path 630 to a light path 638 parallel to second lens optical axis 634. Beam splitter 610 splits the light from light path 638 such that one part of the light continues in light path 638 to sensor 618 and another part of the light is directed along a third optical path 640 parallel to third lens optical axis 636 toward sensor 622.

Note that while in camera 600 upright sub-camera 602 is shown to the left (negative Z direction) of OPFE 608 this is by no means limiting, and the upright sub-camera may be positioned in other locations relative to the OPFE and the two folded sub-cameras. In an example, upright sub-camera 602 may be positioned to the right (positive Z direction) of first folded sub-camera 604 along lens optical axis 634.

In some embodiments, two of the three sub-cameras may be sensitive to the same light spectrum, e.g. the two sub-cameras may both be TOF sub-cameras, VL sub-cameras, IR sub-cameras, thermal imaging sub-cameras, etc. For example, upright sub-camera 602 and one of the folded sub-cameras 604 and 606 may be VL cameras, while the other of folded sub-cameras 604 and 606 a time-of-flight (TOF) camera. For example, upright sub-camera 602 may be a TOF camera, and both folded sub-cameras 604 and 606 may be VL cameras. In an example, sub-camera 602 may be a RGB camera with a RGB sensor, sub-camera 604 may be a TOF camera with a TOF sensor and sub-camera 606 may be a RGB camera with a RGB sensor. In an example, sub-camera 602 may be a RGB camera with a RGB sensor, sub-camera 604 may be a RGB camera with a RGB sensor and sub-camera 606 may be a TOF camera with a TOF sensor. In an example, sub-camera 602 may be a TOF camera with a TOF sensor, sub-camera 604 may be a RGB camera with a RGB sensor and sub-camera 606 may be a RGB camera with a RGB sensor. In other embodiments, two of the three sub-cameras may be TOF cameras, with the third sub-camera being a RGB sub-camera.

According to one example, the three sub-cameras may vary in their lens EFL and image sensor pixel sizes, such that the triple-camera is a zoom triple-camera. Examples of usage and properties of zoom triple-cameras can be found in co-owned U.S. Pat. No. 9,392,188.

Camera 600 may be positioned below a screen with respective holes in pixel arrays above camera apertures 624 and 628. Like other cameras above, camera 600 may be facing the front side or the back side of a host device.

In an example, multi-cameras with single or dual apertures disclosed herein may be used such that one sub-camera outputs a color image (e.g. RGB image, YUV image, etc.) or black and white (B&W) image, and another sub-camera output a depth map image (e.g. using TOF, SL, etc.). In such a case, a processing step may include alignment (in contrast with the dual-camera single aperture alignment that can be calibrated offline) between the depth map image and the color or B&W image in order to connect between the depth map and the color or B&W image.

In an example, multi-cameras with single or dual apertures disclosed herein may be used such that one sub-camera outputs an image with Wide FOV and another sub-camera outputs an image with a narrow (Tele) FOV. Such a camera is referred as a zoom-dual-camera. In such a case, one optional processing step may be fusion between Tele image and Wide image to improve image SNR and/or resolution. Another optional processing step may be to perform smooth transition (ST) between Wide and Tele images to improve image SNR and resolution.

In an example, multi-cameras with single or dual apertures may be used such that one sub-camera outputs a color or B&W image and another sub-camera outputs an IR image. In such a case, one optional processing step may be fusion between the color or B&W image and the IR image to improve image SNR and/or resolution.

In another example, multi-cameras with single or dual apertures disclosed herein may be used such that one sub-camera outputs a Wide image and another sub-camera outputs a Tele image. In such a case, one optional processing step may be fusion between the Tele image and the Wide image to improve image SNR and/or resolution.

In a dual-camera with a single camera aperture, the two resulting images share the same point of view (POV) on the object captured. The effective baseline in this case is equal or close to zero. This is not the case in dual-camera aperture system where the baseline is bigger than zero and defined by the distance between the two optical principal axes. In various examples, any dual-camera with a shared aperture can be combined with another camera to obtain a triple-camera with two apertures for various applications disclosed herein.

Some advantages of dual-camera with a single camera aperture over a dual camera aperture dual-camera may include:

1. In a dual-camera with a single camera aperture no local/per pixels registration is required in order to connect between the two images, which is not true in a dual camera aperture dual-camera where the alignment is dependent on the object distance. By avoiding local/per pixel registration:

a. computational load is dramatically reduced;

b. no registration error is present. Registration errors may result in artifact in the fusion image and/or misalignment between the depth image (e.g. TOF, SL) and the color or B&W image.

2. In a dual-camera with a single camera aperture no occlusions exist between the two images. This is not true in a dual camera aperture dual-camera, where the occluded area is dependent on the object distance (closer object, bigger occlusion). By avoiding occlusion, one obtains:

a. full image alignment between the two images, while in the dual camera aperture dual-camera case, there is missing information on how to align between the two images. This may result in artifacts in the fused (combined) output image and in misalignment between the depth (e.g. TOF, SL) and color or B&W image;

b. computational load is reduced, since in the dual camera aperture dual-camera case some logic module needs to be added to treat the occluded areas.

3. Smooth transition is based on keeping the focused object aligned when switching between the Wide and the Tele image. This means that in the dual camera aperture dual-camera case, an object not in the focus plane will not be fully aligned during the transition (degradation of the image quality). In a dual-camera with a single camera aperture, the transition will be smoothed for all object distances.

In some cases, calibration between the two sub-cameras of a dual-camera with a single camera aperture is required to compensate for assembly error. For example, some misalignment between the center of the two lenses and/or the two sensors (e.g. in dual-cameras 100, 400, etc.) will result in an offset between the two output images, which may be corrected by calibration. In another example, calibration may be required to compensate for differences in lens distortion effects in the two images. The calibration can be done at the assembly stage or dynamically by analyzing the scene captured.

Processing stages for mentioned fusion, smooth transition, and alignment between the TOF/depth map and color/B&W images may include:

1) Fusion:
a. Rectification: overcoming calibration error;
b. Global registration: overcoming global dynamic differences (for example autofocus scaling (“AF scale”);
c. Fusion application: combining images to improve resolution and SNR according to a zoom factor requested by the user.

2) Alignment:
a. Rectification: overcoming calibration error;
b. Global registration: overcoming global dynamic differences (for example AF scale).

3) Smooth transition:
a. Rectification: overcoming calibration error;
b. Global registration: overcoming global dynamically differences (for example AF scale);
c. Set the image scale—according to the zoom factor requested by the user.

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

All patents and patent applications mentioned in this specification are herein incorporated in their entirety by reference into the specification, to the same extent as if each individual patent or patent application was specifically and individually indicated to be incorporated herein by reference. In addition, citation or identification of any reference in this application shall not be construed as an admission that such reference is available as prior art to the present disclosure.

What is claimed is:

1. An imaging system, comprising:
a first, upright camera; and
a second, folded camera comprising an aperture positioned in a first light path between a triangular optical path folding element (OPFE) and an object or scene to be imaged, wherein the triangular OPFE has a first reflecting surface configured to reflect light from the first light path to a second light path, an image sensor lying in an image sensor plane that is substantially perpendicular to the first light path, a quadrangular OPFE configured to receive light entering from the second light path, and a final reflecting surface configured to reflect light traveling in the quadrangular OPFE to a last light path towards the image sensor, wherein the first reflecting surface and the final reflecting surface are parallel and wherein a center of the quadrangular OPFE is offset from the aperture.

2. The imaging system of claim 1, further comprising a processor configured to output video output images with a smooth transition when switching between a lower zoom factor (ZF) value and a higher ZF value or vice versa, by using information that includes first camera and second camera white balance or exposure time to reduce changes in color or brightness upon the smooth transition and by using image pixel information to reduce parallax artifacts.

3. The imaging system of claim 1, wherein the first camera has a first number of pixels with a first pixel size, wherein the second camera has a second number of pixels with a second pixel size, and wherein the second camera has a second number of pixels different from the first number of pixels.

4. The imaging system of claim 2, wherein the first camera is configured to generate a first color image, and the second camera is configured to generate a second color image.

5. The imaging system of claim 3, wherein the first pixel size is different from the second pixel size.

6. The imaging system of claim 4, wherein the processor is configured above a certain zoom factor to generate an output image based on the second camera incorporating at least some image data from the first camera.

7. The imaging system of claim 4, wherein the processor is configured to generate a third depth image based on the first color image and on the second color image.

8. The imaging system of claim 4, wherein the processor is configured to achieve the smooth transition by aligning image data from the first and second cameras when switching from a first image to a second image or vice versa.

9. A camera, comprising:
an aperture positioned in a first light path between a triangular optical path folding element (OPFE) and an object or scene to be imaged, wherein the triangular OPFE has a first reflecting surface configured to reflect light from the first light path to a second light path;
an image sensor lying in an image sensor plane that is substantially perpendicular to the first light path;
a quadrangular OPFE configured to receive light entering from the second light path; and
a final reflecting surface configured to reflect light traveling in the quadrangular OPFE to a last light path towards the image sensor, wherein the first reflecting surface and the final reflecting surface are parallel and wherein a center of the quadrangular OPFE is offset from the aperture.
